(19) United States
(12) Patent Application Publication
(10) Pub. No.: US 2006/0041829 A1
(43) Pub. Date: Feb. 23, 2006

(54) Selective composition of a media event

(76) Inventor: Christopher A. White, Redmond, WA (US)

Correspondence Address: FSP LLC;Attn: Charles A. Mirho, P.O. Box 890, Vancouver, WA, 98666, US

(21) Appl. No.: 10/922,045

(22) Filed: Aug. 18, 2004

(51) Int. Cl. G06F 17/21; H04N 5/44; G06F 15/16

(52) U.S. Cl. 715/500.1; 715/716; 709/219

(57) ABSTRACT

A media terminal selects a subset of a set of media components associated with a media experience available via a media network. The media terminal receives from the media network media components corresponding to the selected subset of media components, and mixes and plays the media components corresponding to the subset of media components.

### TECHNICAL FIELD

The present disclosure relates to personalized media experiences.

### BACKGROUND

A common complaint is that people are forced to experience unwanted aspects of a media event. For example, a sports event broadcast may include the participation of a commentator that a person dislikes. The person may wish to view the sports broadcast of one media provider, while experiencing the commentary provided by another, along with captioning from a third. Unfortunately, media events are communicated to the person bundled in an indivisible “one-size-fits-all” package, and people do not have the option of unbundling certain components of the media event, and/or repackaging the media event with media components from multiple sources.

### SUMMARY

The following summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the figures, and from the claims (which follow the detailed description).

A media terminal selects a subset of a set of media components associated with a media experience available via a media network. The media terminal receives from the media network media components corresponding to the selected subset of media components, and mixes and plays the media components corresponding to the subset of media components. The media terminal may receive the media components corresponding to the selected subset of media components from a plurality of media sources of the media network. The media network may authorize access to at least one component of the media components corresponding to the selected subset of media components before communicating the at least one component to the media terminal. The media network may apply at least one of user preferences and media terminal capabilities to the selected subset of media components to determine the media components corresponding to the selected subset of media components to communicate to the client (or the media terminal may do so in selecting the desired media components).

Alternatively, the media terminal may select a subset of a set of media components associated with a media experience available via a media network, communicate the selections to the media network, and the media network may mix media components corresponding to the selected subset of media components into a composite media and communicating the composite media to the media terminal.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a media event environment.

FIG. 2 is a block diagram of an embodiment of a media event network.

FIG. 3 is an action diagram of an embodiment of a process of providing customized media experience.

FIG. 4 is an action diagram of another embodiment of a process of providing customized media experience.

FIG. 5 is an action diagram of an embodiment of a process of providing customized media experience according to a person's preferences and device capabilities.

FIG. 6 is an action diagram of another embodiment of a process of providing customized media experience.

FIG. 7 is a block diagram of an embodiment of a system to select media components of a customized media experience.

FIG. 8 is an action diagram of another embodiment of a process of providing customized media experience.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

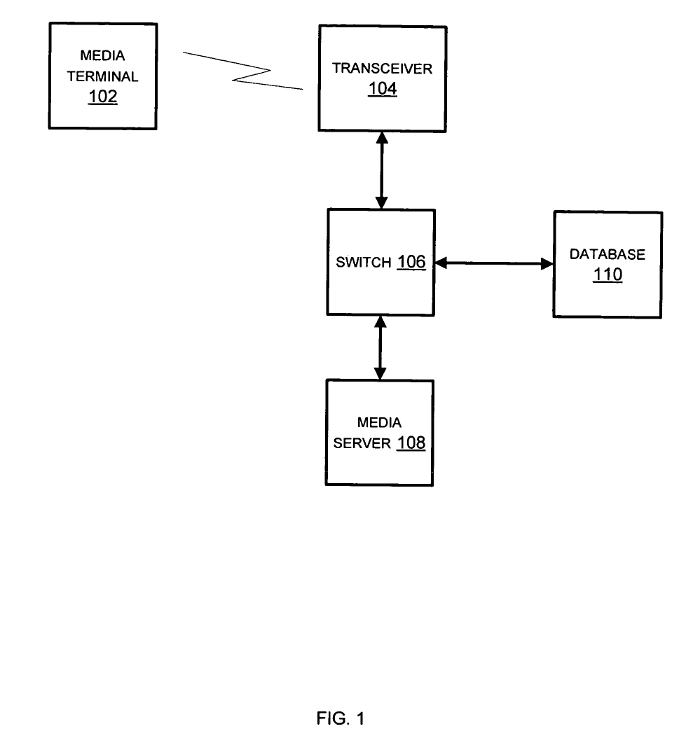

FIG. 1 is a block diagram of an embodiment of a media event environment. The media event environment comprises a transceiver 104 which is coupled to a switch 106. The switch 106 is coupled to a database 110, and a media server 108. A media terminal 102 communicates with elements of the media event environment via a transceiver 104. The transceiver 104 is a wireless transmitter/receiver arrangement that acts as an entry point to the media environment. Other entry points may be employed including Ethernet ports, dial-up (Plain Old Telephone Service) connections, wired broadband connections such as Digital Subscriber Line and cable modems, to name just a few of the possibilities.

The switch 106 is any device which enables the communication of information from a source (which can be another switch or intermediate device) towards a destination device to which the information will ultimately be delivered. This movement of information may be referred to as switching or routing. The switch 106 may be a mobile switching center, optical switch, Ethernet 10/100/100 switch, wireless switch and/or router, among other things. Most networks will comprise at least one, meaning one or more, switches.

The media server 108 is a network device that receives media selections from one or more media terminals. The database 110 is a data repository. Examples include a subscriber—e.g. user-information database, such as may be implemented in wireless networks using a Home Location Registry (HLR) and/or Visitor Location Registry (VLR).

The switch 106, media server 108, and database 110 (along with other well-known devices not shown in the interest of not obscuring the present invention) are element of a media network. The media network is a collection of devices that cooperate to provide media events and/or components thereof to media terminals. Examples are the Internet, high-speed data networks, broadcast networks (such as satellite networks), cellular telephone and other wireless access networks, and cable networks. In addition to the devices that enable communications and provide switching, the media network is comprised of components that may provide user authorization and other user information and usage tracking. The media network may also comprise elements that provide media content.

The media network (e.g. the devices comprised thereby) includes at least one processor and logic that, when applied to the at least one processor results in the media network carrying out acts of procedures described herein. A “processor” is a circuit comprising data and/or instruction processing circuits. “Logic” includes software, and/or firmware, and/or circuits defining operations of a device.

The media terminal 102, also known as a media terminal, is a device that receives media information from the media network. The media terminal 102 communicates with the media network to create a customized media event. This communication provides information from a source to a destination across a distance, for example using electrical, optical, or wireless technology. Examples of media terminals are personal computers, televisions, personal digital assistants, laptop computers, and/or mobile communication devices, for example, mobile phones or other devices providing a wireless communications capability. A media terminal is capable of receiving media event information from the media network. Examples representative of media event information are news programs, news tickers, sports programs, documentaries, interviews, and concerts.

The media terminal 102 comprises of at least one processor and logic that, when applied to the at least one processor, results in the media terminal 102 carrying out acts of procedures described herein.

In one embodiment, the media terminal 102 selects a subset of a set of media components associated with a media event, the media event being available via the media network. The selection of the subset of components may be performed directly by a media terminal user. Alternatively, the selection may occur based on user preferences, client terminal capabilities, and other factors. The media components are selectable portions of the media event. Examples could be but are not limited to audio commentary in English, audio in other languages, video formatted in different display sizes and resolutions, subtitles corresponding to speech, a news ticker, short moving or still videos describing sports player biographies and statistics, video of a sports events, and video from different camera angles and locations. The media component set is the totality of all media components available for this media event via the media network. The subset can include less than or all of the members of the media component set.

The database 110 comprises information about a subscriber associated with the media terminal 102. A subscriber may be an individual or a group of individuals (e.g. a group, association, company, or other legal entity). For example, the database 110 may comprise subscriber authorization information. The authorization information may include access permissions for the client regarding selected media components.

In one embodiment, the media terminal 102 receives from the media network media components corresponding to the selected subset of media components. The media terminal 102 mixes and plays the media components corresponding to the selected subset of media components. “Mixing” involves combining the media components into a composite media, such as a stream, broadcast, and/or file comprising the result of the mixing of media components. “Playing” involves rendering the information in a fashion that can be experienced by people. Examples are the display of images and video, and playing sound on speakers.

In an alternative embodiment, the media terminal 102 selects a subset of the set of media components of the media event. The media network mixes the media components that correspond to the selected subset of media components into a composite media. The composite media is delivered to the media terminal 102 by way of the media network.

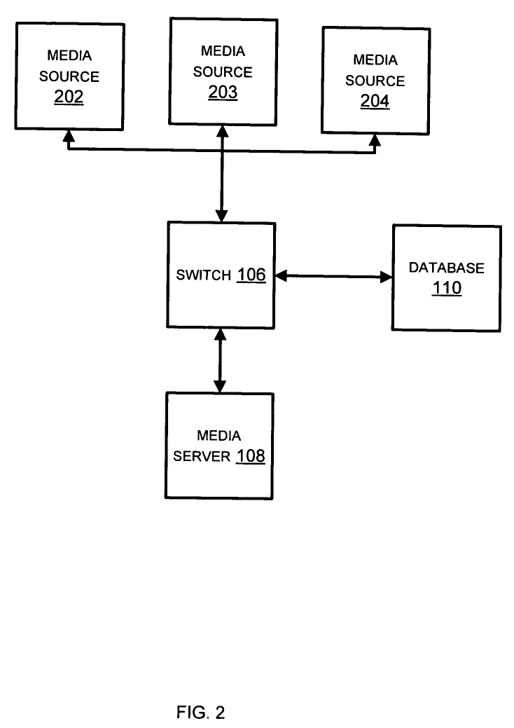

FIG. 2 is a block diagram of an embodiment of a media event network. The media event network comprises first, second, and third media sources 202, 203, 204. The media sources 202-204 are devices that provide media via the media network. In some cases a media source can be a media server. In one embodiment, the media terminal 102 communicates with the media network to receive the media components corresponding to the selected subset of media components from the plurality of media sources 202-204. The media terminal 102 mixes and plays the selected subset of media components.

In an alternative embodiment, a media server 108 receives, from the plurality of media sources 202-204, the media components corresponding to the selected subset of media components. The media server 108 mixes the media components corresponding to the selected subset of media components into a composite media. The media server 108 communicates the composite media to the media terminal 102.

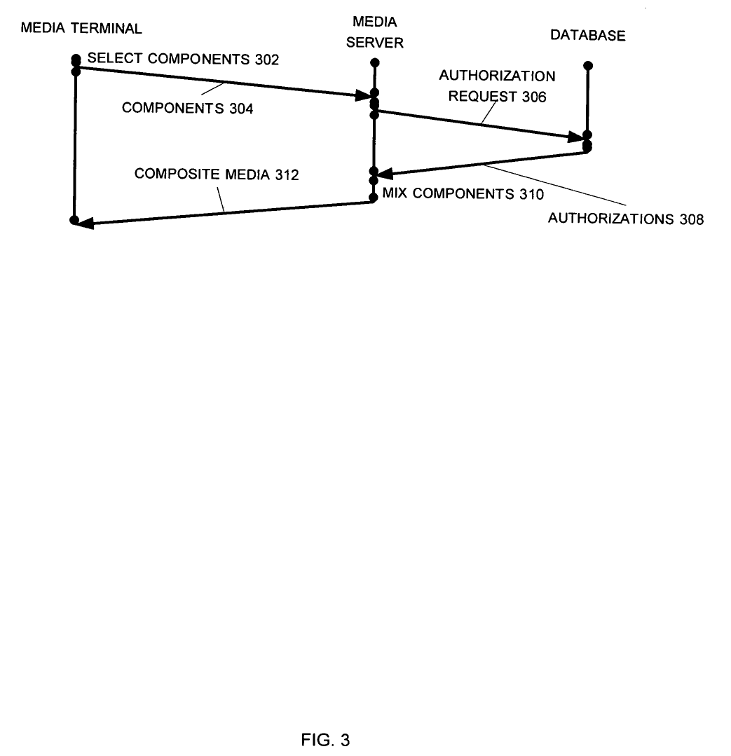

FIG. 3 is an action diagram of an embodiment of a process of providing a customized media experience. At 302 components of a media event are selected. At 304 the media terminal provides component selections to the media server. At 306 the media server provides authorization requests to the database, to determine whether the subscriber associated with the media terminal should be provided access to the selected media components. At 308 the database provides media component access authorizations to the media server. At 310 the media server mixes the selected media components that have been authorized. At 312 the media server provides a composite media to the media terminal.

Thus, in one embodiment the media terminal communicates a selected subset of media components to the media network. The media network authorizes access to at least one media components corresponding to the selected subset of media components before communicating the at least one media components corresponding to the selected subset of media components to the media terminal.

In an alternative embodiment, the media server does not mix the selected media components. Instead, the media server communicates the selected subset of media components to the media terminal at 312. In this embodiment, the media terminal mixes the components into a composite media.

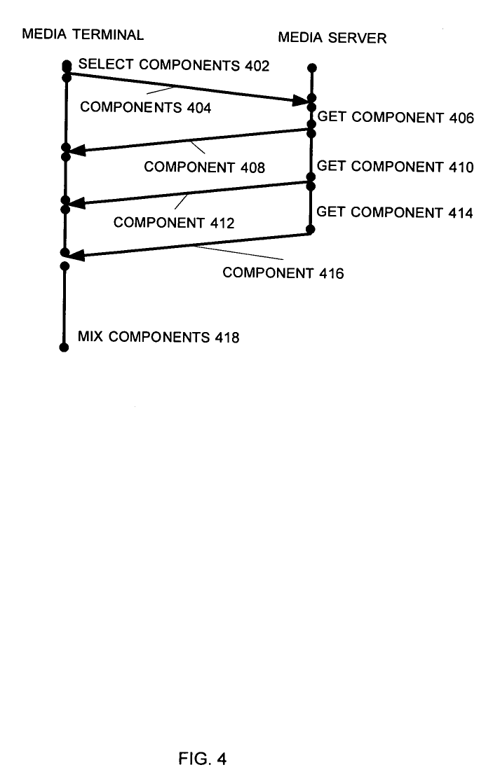

FIG. 4 is an action diagram of another embodiment of a process of providing customized media experience. At 402 the media component selections are made at the media terminal. At 404 the media terminal provides component selections to the media server. At 406 the media server receives a first media component. At 408 the media server provides the first media component to the media terminal. At 410 the media server receives a second media component. At 412 the media server provides the second media component to the media terminal. At 414 the media server receives a third media component. At 416 the media server provides the third media component to the media terminal. Thus the media server acts as an intermediary to receive selected media components and provide them to the media terminal. At 418 the media terminal mixes the components.

In another embodiment, the media server may cause the media sources to provide to the media terminal the media components corresponding to the selected media components, without the media server receiving the media components corresponding to the selected media components.

In an alternative embodiment, the media terminal receives from at least one media sources the media components corresponding to the selected subset of media components. The media server mixes the media components corresponding to the selected subset of media components into a composite media, and communicates the composite media to the media terminal.

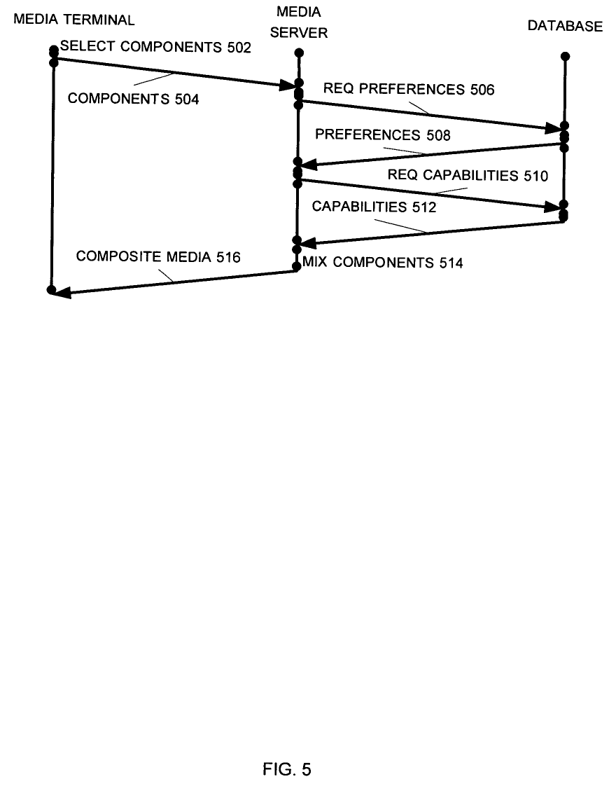

FIG. 5 is an action diagram of an embodiment of a process of providing a customized media experience according to a person's preferences and device capabilities. At 502 component selections are made at the media terminal. At 504 the media terminal provides the component selections to the media server. At 506 the media server requests, from the database, media preferences for the user of the media terminal. User preferences are preferences of the user of the terminal (and/or a subscriber associated with the terminal) such as media format, delivery, layout, color scheme, and so on. At 508 the database provides the user's preferences to the media server. At 510 the media server requests the media device's capabilities from the database. Examples of media device capabilities are information processing speed, display dimensions, color capabilities, display resolution, and stereo capability.

At 512 the database provides the media device capabilities to the media server. At 514 the media server mixes media components that conform to the user's selections, preferences, and the media device capabilities. At 516 the media server provides composite media to the media terminal.

Thus, the media components corresponding to the selected subset of media components are determined at least in part according to at least one of the user preference information and the media device capabilities information. The media components corresponding to the selected components are mixed by the media server and communicated to the media terminal.

In another embodiment, the media terminal applies at least one of user preferences and media terminal capabilities to at least in part determine the selected subset of media components.

In yet another embodiment, either the media server or the media terminal apply at least one of user preference and terminal capability information to the media component selections, to determine at least in part the media components corresponding to the selected subset of media event components. The media server communicates those determined components to the media terminal, and the media terminal mixes the components into composite media.

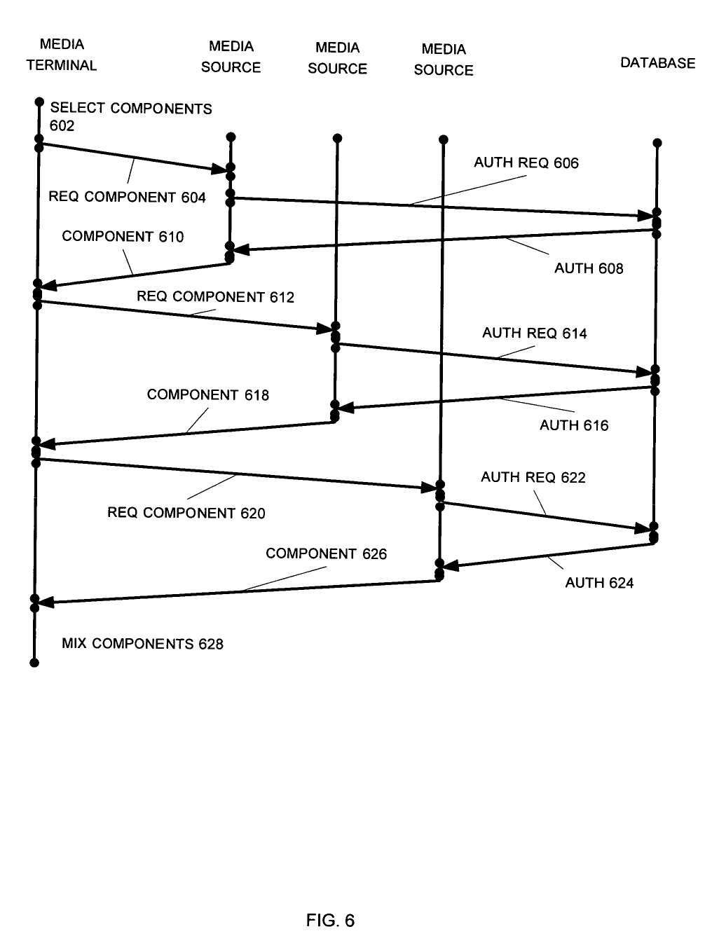

FIG. 6 is an action diagram of another embodiment of a process of providing a customized media experience. In this embodiment, the media terminal communicates with at least one media source to obtain the selected subset of media event components. At 602 media component selections are made at the media terminal. At 604 the media terminal requests a first media component from a first media source. At 606 the first media source provides a request to the database to authorize access to the first media component by the subscriber associated with the media terminal. At 608 the database authorizes access to the first media component. At 610 the media source provides the first media component to the media terminal.

The same process is carried out for the second and third media components. At 612 the media terminal requests a second media component from a second media source. At 614 the second media source provides a request to the database to authorize access to the second media component by the subscriber. At 616 the database authorizes access to second media component. At 618 the second media source provides the second media component to the media terminal. At 620 the media terminal requests a third media component from a third media source. At 622 the third media source provides a request to the database to authorize access to the third media component by the subscriber. At 624 the database authorizes access to the third media component. At 626 the media source provides the third media component to the media terminal. At 628 the media terminal mixes the media components.

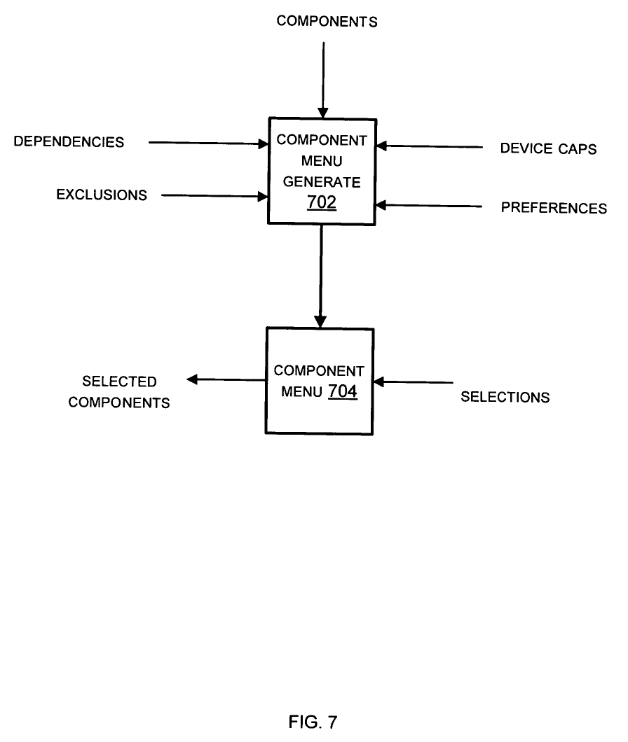

FIG. 7 is a block diagram of an embodiment of a system to select media components of a customized media experience. The component menu generator 702 generates a component menu 704, according at least in part to media component dependencies, exclusions, available components for the media event, media terminal device capabilities, and user preferences. Selections are made from the component menu 704 and the selected subset of event components is generated.

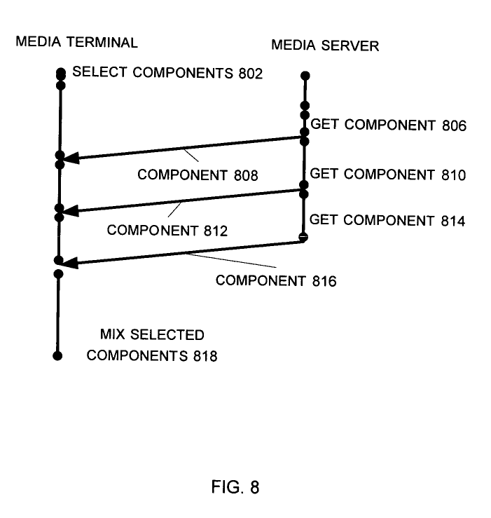

FIG. 8 is an action diagram of another embodiment of a process of providing a customized media experience. In this embodiment, the media network provides all components of the media event to the media terminal (for example, via broadcast), and the media terminal selects components of the media event to mix and play. At 802 media component selections are made at the media terminal. At 806 the media server provides the first media component to the media terminal. At 810 the media server gets a second media component. At 812 the media server provides the second media component to the media terminal. At 814 the media server gets a third media component. At 816 the media server provides the third media component to the media terminal. Of course, the media components may be provided substantially simultaneously, as part of a broadcast. At 818 the media terminal mixes selected ones of the first, second, and third media components.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

What is claimed is:

1. A method comprising:
a media terminal selecting a subset of a set of media components associated with a media experience available via a media network;
the media terminal receiving from the media network media components corresponding to the selected subset of media components; and
the media terminal mixing and playing the media components corresponding to the subset of media components.

2. The method of claim 1 further comprising:
the media terminal communicating selections of the selected subset of media components to the media network.

3. The method of claim 1 further comprising:
the media terminal receiving the media components corresponding to the selected subset of media components from a plurality of media sources of the media network.

4. The method of claim 1 further comprising:
the media network authorizing access to at least one component of the media components corresponding to the selected subset of media components before communicating the at least one component to the media terminal.

5. The method of claim 1 further comprising:
the media network applying at least one of user preferences and media terminal capabilities to the selected subset of media components to determine the media components corresponding to the selected subset of media components to communicate to the client.

6. The method of claim 1 further comprising:
the media terminal applying at least one of user preferences and media terminal capabilities to determine the selected subset of media components.

7. A method comprising:
a media terminal selecting a subset of a set of media components associated with a media experience available via a media network;
the media terminal communicating selections of the selected subset of media components to the media network; and
the media network mixing media components corresponding to the selected subset of media components into a composite media and communicating the composite media to the media terminal.

8. The method of claim 7 further comprising:
the media network authorizing access to at least one component of the media components corresponding to the selected subset of media components before mixing the media components corresponding to the selected subset of media components into a composite media.

9. The method of claim 7 further comprising:
a media server of the media network receiving, from a plurality of media sources of the media network, the media components corresponding to the selected subset of media components, mixing the media components corresponding to the subset of media components into a composite media, and communicating the composite media to the media terminal.

10. The method of claim 7 further comprising:
the media network applying at least one of user preferences and media terminal capabilities to the selected subset of media components to determine the media components corresponding to the subset of media components to communicate to the client.

11. The method of claim 7 further comprising:
the media terminal applying at least one of user preferences and media terminal capabilities to determine the selected subset of media components.

12. A method comprising:
a media terminal selecting a subset of a set of media components available via a media network;
the media terminal receiving from the media network the set of media components; and
the media terminal mixing and playing only the subset of the set of media components.

13. The method of claim 12 further comprising:
the media terminal applying at least one of user preferences and media terminal capabilities to determine the subset of the set of media components.

14. A media terminal comprising:
at least one processor; and
logic that when applied to the at least one processor results in the media terminal
selecting a subset of a set of media components associated with a media experience available via a network;
receiving media components corresponding to the selected subset of media components from the media network; and
mixing and playing the media components corresponding to the selected subset of media components.

15. The media terminal of claim 14 further comprising logic that when applied to the at least one processor results in the media terminal receiving the media components corresponding to the selected subset of media components from a plurality of media source of the media network.

16. The media terminal of claim 14 further comprising logic that when applied to the at least one processor results in the media terminal:
communicating selections of the selected subset of media components to the media network; and
receiving from the media network a composite media produced by mixing the media components corresponding to the selected subset of media components.

17. The media terminal of claim 14 further comprising logic that when applied to the at least one processor results in the media terminal:
applying at least one of user preferences and media terminal capabilities to determine the selected subset of media components.

18. The media terminal of claim 14 further comprising logic that when applied to the at least one processor results in the media terminal:
receiving from the media network the set of media components; and
mixing and playing the selected subset of the set of media components.

19. The media terminal of claim 14 further comprising:
a wireless phone.

20. A system comprising:
at least one processor;
logic that when applied to the at least one processor results in
receiving a media experience selection, the media experience comprising a set of media components;
receiving selections of a selected subset of media components of the set of media components;
determining media components corresponding to the selected subset of media components; and
mixing the media components corresponding to the selected subset of media components into a composite media.

21. The system of claim 20 further comprising logic that when applied to the at least one processor results in
applying at least one of user preferences and media component capabilities to the selected subset of media components to determine the media components corresponding to the selected subset of media components.

22. The system of claim 20 further comprising logic that when applied to the at least one processor results in
authorizing access to at least one component of the media components corresponding to the selected subset of media components before mixing the media components corresponding to the selected subset of media components into a composite media.
